(19) United States
(12) Patent Application Publication
(10) Pub. No.: US 2002/0022492 A1
(43) Pub. Date: Feb. 21, 2002

(54) Communication system

(75) Inventors: Ilan Barak, Netanya (IL); David Aviv, Re'ut (IL)

Correspondence Address: LAW OFFICE OF BARRY R LIPSITZ, 755 MAIN STREET, MONROE, CT, 06468, US

(73) Assignee: Mapco Ltd. c/o Adv. Haim Efrima, Tel-Aviv (IL)

(21) Appl. No.: 09/924,295

(22) Filed: Aug. 8, 2001

(30) Foreign Application Priority Data
Aug. 9, 2000 (IL) 137783

(51) Int. Cl. H04Q 7/20

(52) U.S. Cl. 455/457; 455/456

(57) ABSTRACT

A method of providing geographical information such as locations of communication network end devices, participating in a telephone or data conversation, by using an identifier of one or more of said devices to retrieve associated geographical information. The list of identifiers, which can be identification numbers, and the geographical information associated therewith are arranged within a computer database in such a way as to enable the linking, retrieval and digital transmission of selected geographical information on a communication line or wireless communication.

### FIELD OF THE INVENTION

The present invention relates to information transmitted through communication systems and more specifically to identification of network end devices, such as telephone devices, computers, facsimile machines, cellular phones, portable computers and the like.

### BACKGROUND OF THE INVENTION

In today's telephone and Internet networks, the caller's device identification number (herein after “IDN”, also known as caller ID presentation-“CLIP” ) is transmitted to the receiver telephone device. The IDN generally known as the “telephone number” and is, as a matter of fact, the number of the telephone line, as set in the telephone company. The receiver phone device can display the caller identification number and also to store it on a memory device for a later use. The IDN is useful in helping the recipient of the phone call to identify the caller before actually answering the phone call. Moreover, the recipient phone device can make a list of the received IDNs which can be displayed at will. Facsimile machines can also print this list, and computers can both display and print the list of IDNs.

However, there are cases in which the IDN supplies too little information about the caller. For example, in case of an emergency phone call, it would be very helpful for the police to know the exact location of the caller without the need of the caller to explain his location. Another potential use is in food delivery business. A restaurant which receives a food delivery order, needs to know where exactly to deliver the food. This is important in order to shorten the time of the delivery trip, so that the food arrives at the client location hot and tasty.

There is also a need for a person phone calling another person to identify the recipient location. This could be helpful when these two persons wish to reach each other.

Therefore, there is a need to provide geographical information about the location of telephone devices (also computers and facsimile machines) which participate in a phone/data conversation.

### SUMMARY OF THE INVENTION

According to the present invention, there is provided a method of providing geographical information such as locations of communication network end devices, participating in a telephone or data conversation, by using the identification number (herein after “IDN”) of one or more of said devices as identifiers of geographical information. The IDN list and the geographical information concerning these IDNs is arranged within a computer database so that for each IDN a specific geographical information can be linked, retrieved and sent as digital information on a communication line or wireless communication.

Another aspect of the present invention is that, a telephone integrated with a computerized system, is able to find a geographic map on which the geographical information can be drawn, and the map with the caller location can be displayed on a screen controlled by a computer or other programmable computer chip, for the recipient use, at the time of the conversation, or at a later time, even in the case when a conversation didn't take place.

Yet another aspect of the present invention is that a telephone integrated with a computerized system, is able to display a geographic map, which contains its own geographical information clearly marked on the map.

Still another aspect of the present invention is a database which links a communication device IDN to a specific geographical information.

A further aspect of the invention is that a computer, which can be connected to the communication network, is able to search said data base, to find geographical information corresponding to an IDN.

Yet another aspect of the invention is that geographical information data is transmitted to network end devices participating in a telephone or data conversation.

Yet another aspect of the invention is that the map with the conversation participants' exact locations, clearly marked on the map, can be stored on a computer file or printed by a computer printer, or can be transmitted to another computer or network end device.

Yet another aspect of the invention is that the map with the conversation participants' exact locations depicted on the map can be combined with additional business data to be used by delivery service or the like.

Yet another aspect of the invention is that a map, with the conversation participants' exact location clearly marked on the map, can be displayed on a graphic display of a cellular phone.

Still another aspect of the invention is that a cellular phone can store a data base of geographical information linked to a list of plurality of IDNs on a memory device within its housing or the cellular phone can be connected to such database, placed in another portable case or stationary computer.

Still another aspect of the invention is that all the callers to a specific telephone number can be grouped into a list having common social or economical parameters and the group can be depicted on a map for a business or marketing purpose.

Still another aspect of the invention is that all the callers to a “call center” can be grouped into different groups having certain common interest or characteristics and later these lists of callers can be used in marketing through telephone or research groups.

### BRIEF DESCRIPTION OF THE DRAWINGS

The present invention will be further understood and appreciated from the following detailed description taken in conjunction with the drawings in which:

FIG. 1 is a schematic drawing of a telephone network incorporating the invention.

FIG. 2 is a schematic drawing of telephone conversation signals of the prior art.

FIG. 3 is a schematic drawing of one example of telephone conversation signals incorporating the invention.

FIG. 4 is a schematic drawing of an integrated telephone-computer system constructed and operative according to one embodiment of the invention.

FIG. 5 is a schematic drawing of an internet network incorporating one embodiment of the invention.

FIG. 6 is a schematic drawing of a mobile telephone to stationary phone network incorporating one embodiment of the invention.

FIG. 7 is a schematic drawing of a typical map with the location of the caller according to one embodiment of the invention.

FIG. 8 is a schematic drawing of an order form according to one embodiment of the Invention, with the map and caller location marked thereon.

### DETAILED DESCRIPTION OF THE INVENTION

According to the present invention, there is provided a method of providing geographical information, such as locations of communication network end devices participating in a telephone or data conversation, by using an identifier, such as the identification or telephone number (herein after “IDN”) of one or more of said devices as identifiers of geographical information. The IDN list, and the geographical information associated with these IDNs, are arranged within a computer database so that, for each IDN, specific geographical information can be linked, retrieved and sent as digital information on a communication line or wireless communication.

The present invention further relates to a method of creating, storing and associating geographical information with communication network system end devices (including telephone networks, also known as PSTN), and systems and devices which use this method and products of this method.

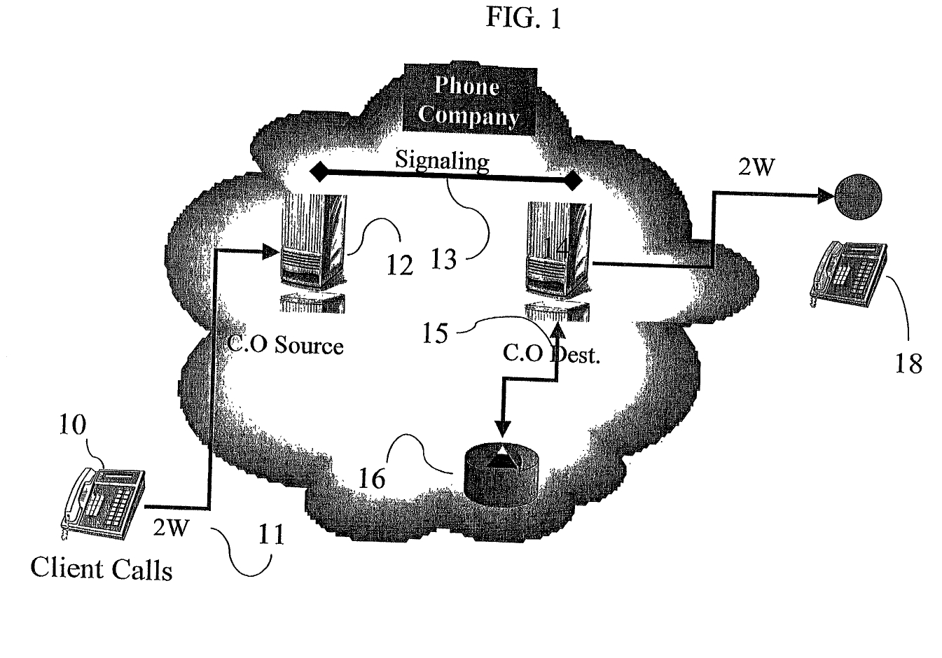

FIG. 1 is a schematic drawing of an existing telephone network system incorporating the invention. As known from the prior art, a person (not shown) using the telephone device 10 dials a phone number corresponding to the telephone device 18. In the illustrated example, line 11 has generally two wires (also known as 2W) which carry analogue electrical signals corresponding to the number dialed. These signals are generated by the telephone 10. A computerized switchboard 12 (also known as C.O Source) placed at the telephone company facility identifies telephone 10 request for a line, and attaches to this new conversation an identification number (herein after “IDN”), which is the line number, also known as the “telephone number”. Computerized switchboard 12 receives the dialing signals and transforms them into digital information, i.e., the number which was dialed. Computerized switchboard 12 performs a search in its communication table to find which computerized switchboard to call, in order to establish a physical line between telephone 10 and telephone 18. In the illustrated embodiment, computerized switchboard 12 selects line 13 (which is one out of many available, but not shown for the sake of clarity) and signals the destination computerized switchboard 14 (also known as C.O Destination). Computerized switchboard 14 receives the signals of computerized switchboard 12 and analyzes them, then computerized switchboard 14 locates the line which connects computerized switchboard 14 to the destination telephone 19 and generates ringing signals, which are electrical pulses that arrive at the telephone 18. The ringing signals cause telephone 18 to generate loud ringing tones. A person at the telephone 18 receives the call by lifting the hand set or by pressing a button. The telephone 18 generates a receiving electrical signal which arrives at the computerized switchboard 14. Then, computerized switchboard 14 signals computerized switchboard 12 to maintain the connection for a phone conversation. The leading signals (also known as ringing signals), which were generated by computerized switchboard 12, contain between them digital signals which are the telephone 10 identification number. The IDN is transmitted to telephone 18, if it is entitled to this service. If not, the computerized switchboard 14 will generate and transmit to telephone 18 only ringing signals. If IDN signals are transmitted and telephone 18 is able to decode and display the IDN signals, the telephone number of telephone 10 will be displayed on the display of telephone 18. If the call is received at telephone 18, a conversation of voices or data can be held. The ringing signals arriving at telephone 18 contain the IDN signals.

The present invention provides, in addition to the IDN, geographical information of participating telephones 10 and/or 18. This geographical information is stored on a computerized database and can be transformed into digital signals and transmitted through communication channels. The geographical information can be transmitted within the conversation signals also. Caller geographical information is preferably stored in a geographical information database. The telephone 18, if it is able to, can decode and store the IDN and the geographical information even if the call was not answered, in case the geographical information is transmitted within the ringing signals. It should be emphasized that identifying a network end device by its IDN is just one possible method of identification, and there could be other methods of identifying a communication network end device. This invention is about linking any possible end device identifier with its geographical information, which includes a stationary and mobile location of the communication network end device. For ease of description only, the invention will be described in the case when the identifier used is the IDN.

The geographical information is found by computerized switchboard 14 by using a database 16, which contains a plurality of IDNs linked to their descriptive geographical information. The geographical database, that enables the providing of geographical information concerning any communication network end device in real time, is an important aspect of the invention. Thus, if telephone 18 is entitled to receive the geographical information signals, computerized switchboard 14 will transmit the geographical information to the telephone 18 and the telephone 18 will decode them and display the geographical information of the telephone 10 in the same manner it decodes and displays the IDN.

The database of the present invention is a computer database that links a plurality of identifiers (here IDNs) to their descriptive geographical information in a manner where a computer provides, for example, an IDN of a coming call, and in return, the database supplies the corresponding geographical information. Generally, this search process consumes less than a second, depending on the size of database, i.e., the number of IDNs stored and the access time to the hardware storing said database and the power of the computer which manipulates the database. As will be shown here, this data base can be stored at various locations of the communication network and practically any computer of the network can host such a database. Any computerized telephone or computer can access such a database to get the corresponding geographical information to any IDN or other identifier of the network.

A database here means any form of geographical data linked to IDNs. The data can be arranged in different forms. One simple example is a table in which there are columns of IDNs and for each IDN, a line of specific geographical data is attached. Usually, the IDNs are arranged in ascending order to minimize the required time to search and locate a specific required IDN. The line attached to an IDN is the required data which the computer reads and transfers according to the present invention.

The database can be stored on a computer hard disk, on a CD ROM (compact disk read only memory), or on a memory chip or on any other memory media. The database preferably contains a database management program, that is able to conduct a search in the table to locate a record in which the IDN is identical to a desired IDN. When such a record is found, the geographical information in the record is the required information. When the computer acquires the geographical information, it can use it in many ways such as: display it, transmit it, print it or combine it with additional information, such as caller name and address. One practical implementation of geographical information is the geographical coordinates where telephone 10 is located. Another form of geographical information can be city name, street name and number of building or apartment in a building where telephone 10 is located. It is possible to build the database of the present invention using any commercially available data base program such as: ORACLE, MICROSOFT SQL7 etc.

FIG. 2 shows the electrical signals of an arriving phone call according to the prior art. The horizontal axis is the time axis, while the vertical axis denotes the voltage of the signals.

The signals propagate from left to right so that signal 21 is the first to arrive at the receiving telephone device (not shown). Signal 21 has higher voltage than signal 23 and it constitutes a ringing signal causing the receiving telephone to generate loud ringing tones. Also, signals 22 are ringing tones. The number of signals 22 can be between 0 to many and they cease when the receiving telephone answers the call. The signal 23 is the IDN. As can be seen, signal 23 is a digital signal ,i.e. representing binary data of ‘0’ and ‘1’ which can be transformed back to decimal values which represent ASCII codes of the alphabet. The signal 24 is the actual human speech transformed into electrical signals and sent from the calling telephone 10 to the receiving telephone 18. The receiving telephone 18 transforms the signals 24 into audio signals, i.e. the voices which were generated at the telephone 10 are now reproduced at telephone 18.

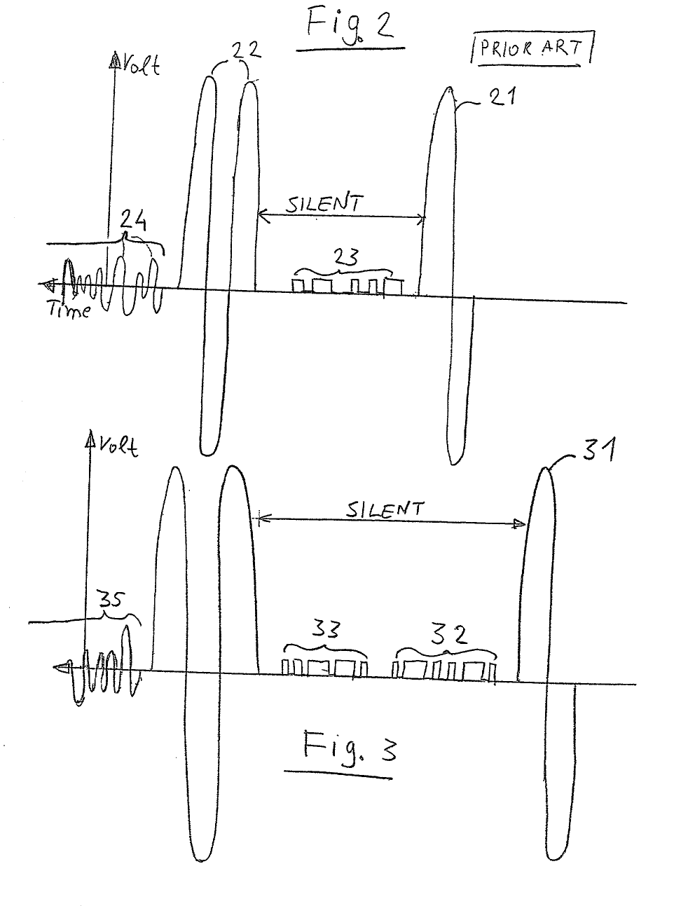

FIG. 3 shows the electrical signals of an arriving phone call, according to one embodiment of the present invention. The general description regarding FIG. 2 applies here also. The first signal to arrive at the receiving telephone is the ringing signal 31. Signal 31 is followed by signal 32 which is the IDN-see signal 23 in FIG. 2. Signal 33 is one of the inventive steps of this invention, it contains geographical information about the location of the caller telephone. The geographical information could be geographical coordinates, address and any other useful information about the network end devices, such as geographical maps containing the location of the network end devices. The coordinates of telephone 10 are generated by computerized switchboard 12 or computerized switchboard 14 which can further transmit the entire maps marked with the locations of the phone call participants. This geographical information is transformed into digital signals 33 and they are transmitted between ringing signals, as illustrated in FIG. 3, or during the conversation signals, in a different frequency, or between voice or data interruptions of the conversation. It should be emphasized that the size, i.e. the voltage of signals 33, as shown, is exemplary only, and does not limit them from being of other voltage or frequency, and their location between the leading signals or the conversation signals 35 could be anywhere-it is just a matter of choice and agreement between telephone manufacturers and software manufacturers.

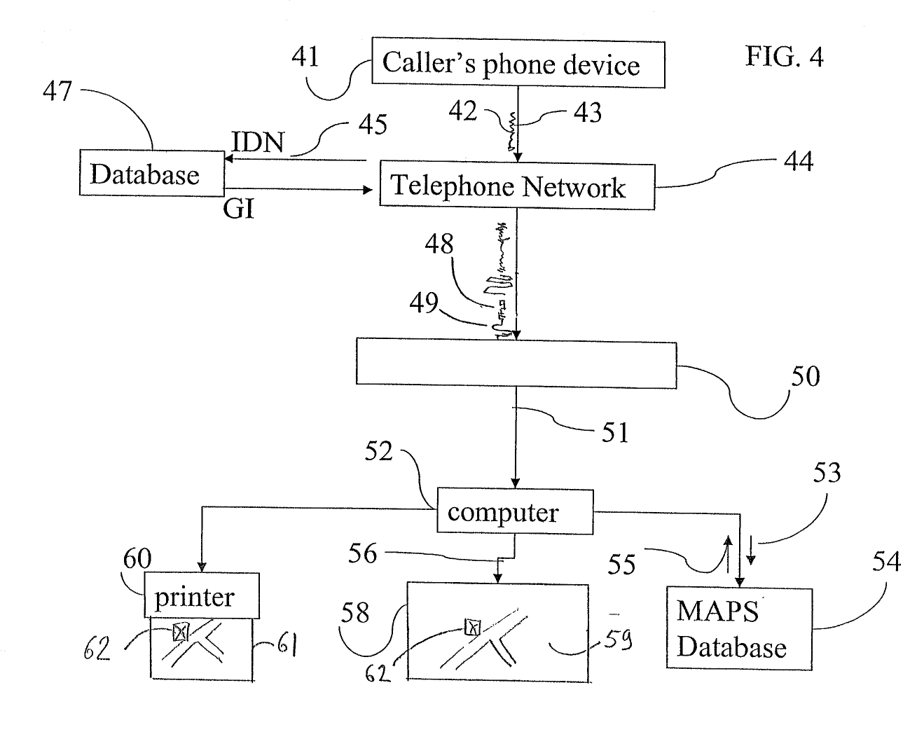

FIG. 4 is a schematic drawing of a preferred embodiment of the invention. The caller telephone device 41 generates dialing signals 42, which are carried through the telephone line 43 to the computerized telephone network 44. A computer of the network 44 conducts a search in a computerized database 47 by delivering the caller telephone IDN. In response, the database finds the caller geographical information, for example, these could be the geographical coordinates which correspond to the IDN. The caller geographical information data is transmitted to the telephone network 44, which now adds the caller geographical information signals, immediately after the IDN signal or later between other signals. The leading telephone signals 49, i.e. the ringing signal with the IDN and the caller geographical information 48, arrive at the receiving telephone device 50. The telephone 50 transfers the caller geographical information signal through a cable 51 to a receiving computer 52 which is, preferably, in the same room where the telephone 50, the display 58 and the printer 60 are placed. The computer 52 conducts a search in a database 54, which contains geographical maps, to find a map which contains the geographical coordinates of the caller. A map, usually in a rectangular shape, has four corner points. For each corner point there is a pair of X and Y coordinates. Thus, a map describes an area which is defined between X1 and X2 and between Y1 and Y2. If the caller coordinates are X:Y and X1<X<X2 and Y1<Y<Y2 then the caller coordinates are on that map. The computer searches for a map which fulfills these two mathematical conditions, thus containing the caller coordinates. This database is another aspect of the invention.

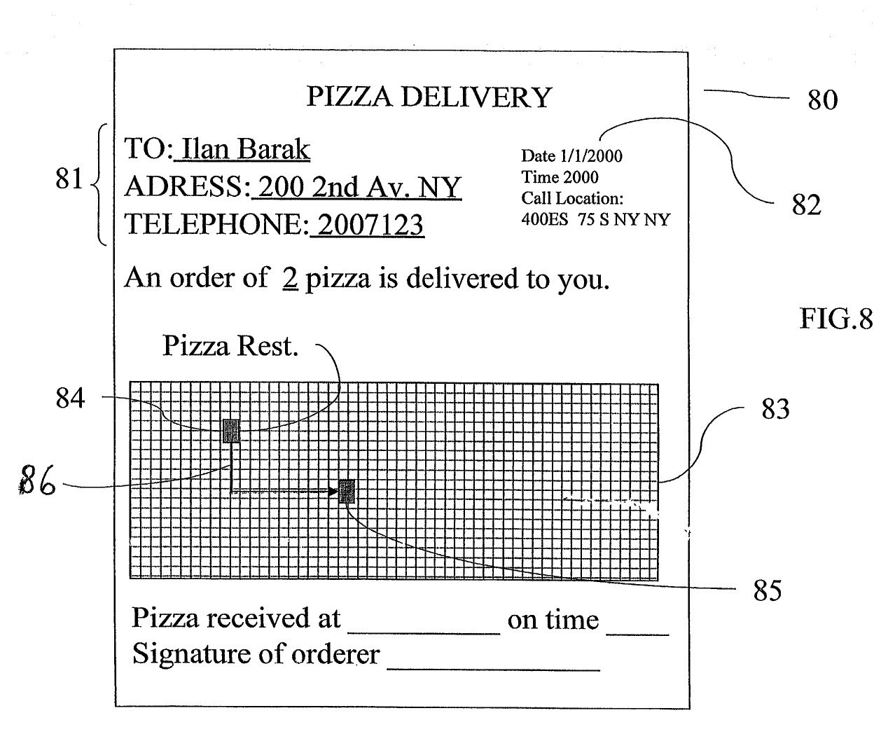

Further, the database 54 can contain a list of IDNs versus caller geographical information so that telephone protocols of today need not be changed to apply this invention. An IDN of a caller is enough data to perform a search in the database to find the caller geographical information of this IDN, so that caller geographical information is not required to be transmitted in order to identify a device participating in a communication session. In any case, the required map 55 is then transferred to the computer 52 which sends the map through cable 56 to a computer display 58. The map 59 is then displayed on the display 58 with a special mark 62 denoting the exact location of telephone 41. Alternatively, or in addition, the computer 52 can send the map 55 to a printer 60 which prints a printed map 61 with the mark 62, depicting the location of the caller telephone 41. The computer 52 can be used to add additional details, to be displayed and printed together, as is explained with regard to FIG. 8.

The present invention is also useful for communication between computers, such as over the Internet, including voice over Internet protocol (VOIP) or telephony over IP (TOIP).

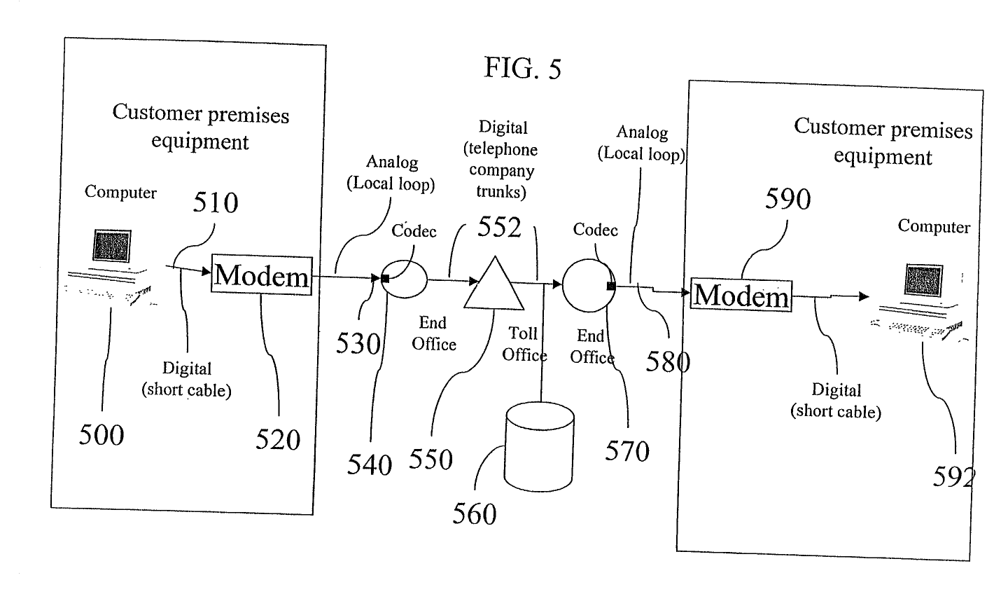

FIG. 5 is a schematic drawing of an Internet network incorporating one embodiment of the invention. As known in the prior art, a computer 500 is connected to a destination computer 592 in a session of data transfer in both directions. Computer 500 is connected through a short (few meters long) cable 510, which convey digital signals from the computer 500 to a modem 520, which transforms these digital signals into analog electrical signals. The signals from the modem 520 arrive at a Codec 540. Codec 540 is a encoder/decoder device which decodes the arriving signals back into digital signals which are then transmitted through digital trunks (cables which are able to transfer large communication volume) 552 of the phone company. A computerized switchboard 550 directs the digital signals to the destination computer 592 via a destination Codec 570 which transform the digital signals into analog signal and transmits them to the modem 590. Modem 590 receives the analog signals and transforms them back into digital signals so that the computer 592 is able to read them.

It is a particular feature of the present invention that a database 560 is provided, in which a search is conducted by computerized switchboard 550, in real time, to find the geographical information of one, or both of the computers 500 or 592, by using their IDNs. The corresponding geographical information can be the entire map, or only the geographical coordinates of one or both computers 500 and or 592. The geographical information can be transmitted to either or both computers. The destination modem 590 decodes the analog signals and transforms them into digital signals which the computer 592 is able to read. As was explained before, the database 560 can be connected directly to either of the computers 500 and 592 and the search in it will be based on the IDN of either of these computers.

It should be noted that a computer conversation is conducted in both directions so that each computer receives the other computer's IDN, so that each of these computers can independently conduct a search in the database 560 provided that this database, or copies of it, are placed and connected to these computers. There are many advantages of this caller geographical information transmittal in real time. For example, two persons who are chatting though their computers would like to know where the other person is located. Another example is in case of purchasing an item in a virtual store. The virtual store management will appreciate the ability to verify the location of its client in order to avoid a fraud purchase by using illegal use of a credit card.

These features of caller geographical information transmittal to both directions, i.e. to both network end devices can be applied to voice conversation as described with regard to FIG. 1.

The network shown in FIG. 5 is very similar to the network shown in FIG. 1. In the Internet network, instead of computerized switchboard 12 and computerized switchboard 14 of FIG. 1, there are Media GateWays (not shown in FIG. 5) which connect computers 500 and 592 of FIG. 5 to the Internet. Instead of computers 500 and 592, other computerized devices could be connected to the Internet network, such as computerized telephone devices to enable voice over internet network, which is also known as voice over Internet protocol (VOIP).

In this environment, the Media GateWays (where analog phones and digital end devices are connected) are controlled by the Call Server (also known as Soft Switch or Media GateWay controller) using protocols, such as SIP, MGCP, H.248, H.323 etc. Thus, the ability to control the duration between the first. and the second ringing patterns is important for providing the caller geographical information to analog phones as done in the public switched telephone network (PSTN)/ISDN environment. Thus, different implementations are needed due to different GateWays manufactured according to different specifications. The caller geographical information database can be located at the Call Server and the search result for a specific IDN, i.e. the caller geographical information, is then transmitted to the GateWay and inserted between the first and the second ringing patterns. For digital devices, such as IP phones or even more sophisticated end devices (known as SIP clients), any other method can be considered.

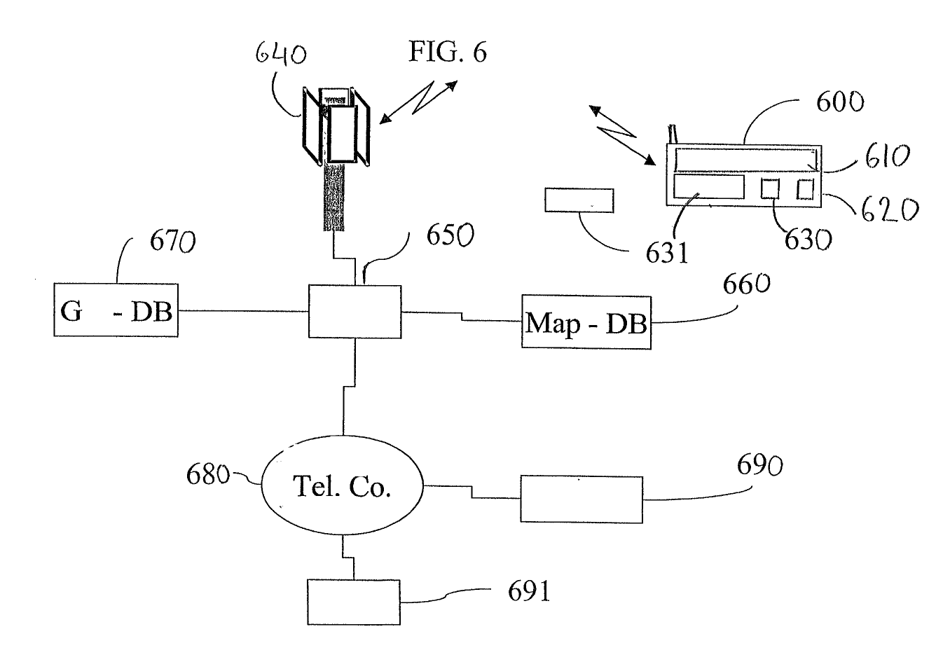

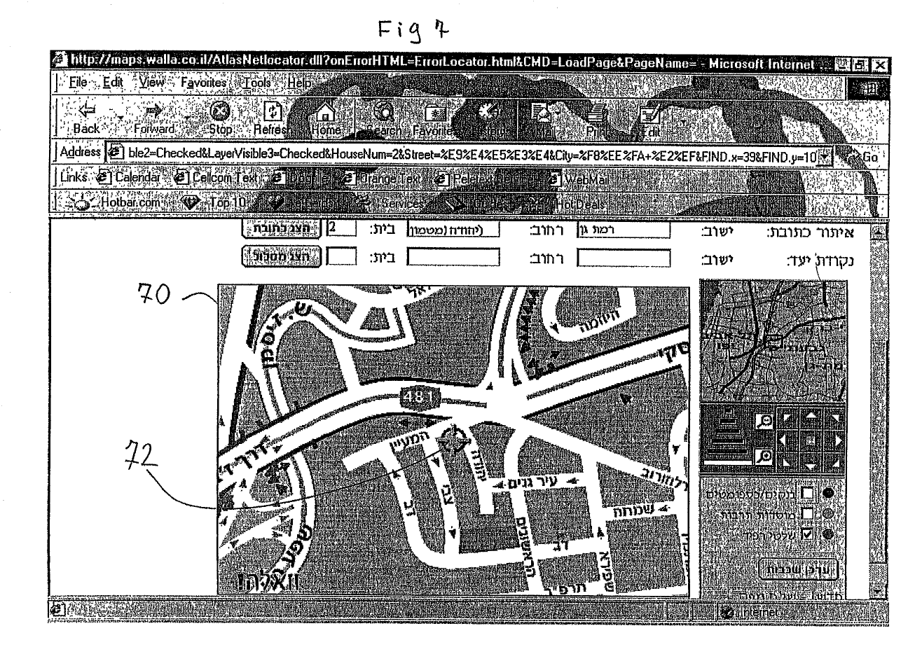

Yet another embodiment of the invention involves the use of cellular phones. FIG. 6 is a schematic drawing of one example of a cellular network incorporating the invention. An antenna 640 represents a cell of a cellular phone network. The cell includes a computer connected to a transceiver (both of them are not shown) which is connected to the antenna 640. A computer 650 of the cellular network is uses the antenna 640 location as a rough location of all the cellular phones connected to that cell, i.e., exchanging transmissions with this cell.

The telephone company computers can locate telephone 690, or internet server 691, as was explained with regard to FIG. 1 and FIG. 5, and transmit their location or the entire map to cellular phone 600.

The cellular phone 600, includes a graphic display 610, which is able to display a map containing the location of any other phone participating in a conversation with itself. A displayed map 610 is shown in FIG. 6, generated by a cellular phone central processor unit (CPU) 620. The CPU 620 uses its own map database 630 and a caller's phone IDN to find and display the appropriate geographical map which contains its own location and the caller's location. Since a cellular phone is mobile, its location is determined by the location of the instant cell to which it is attached. Thus, the cell computer transmits to any cellular phone connected to it, the location of the cell 640. Alternatively, another computer of the network can manage this conversation through the computer of the cell 640.

The cellular phone geographical database 630 can be stored on a computer memory external card 631 which can be inserted into the cellular phone as shown in FIG. 6, and its geographical information can be accessed by the cellular phone CPU 620. The database stores information which links IDN to corresponding caller geographical information. Thus, a cellular phone can display a map with caller's geographical information clearly marked on it. The CPU 620 uses the transmitted IDN of a stationary phone 690 and the database 630 to find the corresponding caller geographical information.

The database 630 and its card form 631 can be updated while inside the cellular phone or by any computer of the cellular network, while the cellular phone is connected to any cell of the cellular network. This database 630, which resides in a cellular phone and alternatively or in addition stored on a replaceable “stick in” memory card 631 (memory here means all possible computer memory media including tiny hard disk, memory chips, magnetic memory etc.), can also be implemented to non mobile phones.

Alternatively, the database which supplies geographical information to the cellular phone 600 about its partners to a phone conversation can reside on any computer of the cellular network. Thus, cellular phone 600, which is connected to the cell 640, receives the location of the cell either from the cell computer or from the computer 650. It is expected that cellular technology will be improved so as to better locate cellular phones connected to a cell, or to a cell array and this improved location, will be transmitted to the cellular phones and stationary phones, using the method described here.

It should be understood that an IDN-caller geographical information database 670 can be located at the cell 640 or at the computer 650, thus providing a caller's geographical information to the computer 650, which can transmit it to any authorized cellular phone or other network end device.

It is also possible to perform an Internet session with an Internet site, stored on a remote computer 691.

FIG. 7 is an example of a map 70 displayed on a computer screen 71 (58 in FIG. 5) at the receiving telephone 18 (see FIG. 1). The location of the calling telephone 10 is clearly marked by 72. It is a particular feature of the present invention that a printout can be provided, by a receiving phone or a computer, including details of the caller, together with a geographical indication of the caller's location, coordinates or street address. Preferably with indication of at least caller's location and most preferably of both caller's and receiver's locations.

FIG. 8 is schematic illustration of one example of a delivery form 80 of a pizza delivery restaurant located in the map 83 at a location 84. The form 80 preferably includes personal identification data 81 and date and time of the order 82. A map 83 indicating the locations of the caller 85 and the restaurant 84 is preferably printed on delivery form 80 or on a separate form associated with the delivery form. According to one embodiment of the invention, the best delivery route 86 between the restaurant 84 and the caller 85 is also indicated on map 83. This form is printed within seconds after an order is accepted in the restaurant. The map 83 is either kept on a database at the restaurant, or transmitted to a computer integrated with the telephone which received the pizza order. This form is another aspect of the invention.

A business incorporating the system of the invention can use the computer system to prepare lists of groups of callers according to the callers' locations and type of order and the like. These groups can be used for marketing purposes such as calling all callers who reside in a certain neighborhood, to offer them a deal. For example, a restaurant can approach its group of clients residing on a specific street and offer them a deal based on a delivery service which is going to take place in their street on a specific time. This client grouping of callers based on their location and optionally on additional characteristics is a particular feature of the invention.

In the discussion about the various aspects of the invention and the various devices which receive geographical information, it should be emphasized that acquiring the geographical data out of received signals can be done in different methods such as done in acquiring the identification number of telephone devices in the prior art. This separation of the geographical information from the other signals can be done by the micro processor of the device by using software or by a specially designed microprocessor with its own software, which is known as a digital signal processing device (DSP).

It will be appreciated that the invention is not limited to what has been described herein above merely by way of example. Rather, the invention is limited solely by the claims which follow.

1. A method of providing information about a device participating in a telephone, or other data communication conversation, comprising:
a. acquiring an identifier of said device;
b. acquiring geographical information related to said identifier; and
c. providing said geographical information to at least one participating device.

2. The method of claim 1 wherein said method further comprises displaying said geographical information on a display of a participating device.

3. The method according to claim 1, wherein geographical information is transmitted to a participating device via a physical line.

4. The method according to claim 1, wherein geographical information is transmitted to a participating device via wireless communication.

5. The method according to claim 1, wherein said communication conversation is performed over a system selected from: a telephone network system, a cellular network system, an internet network system, an intranet network system, television cable network system, a wireless network, a satellite network, or any combination of these systems.

6. The method of claim 1, wherein said geographical information includes a geographical map.

7. The method of claim 1, wherein said geographical information includes geographical coordinates.

8. The method of claim 1, wherein said geographical information includes an address expressed by city name, street name and a number of a building.

9. The method of claim 1, wherein said geographical information is transmitted to said device during any stage of the conversation.

10. The method of claim 1, wherein said geographical information is transmitted to said device before the conversation.

11. The method of claim 2, wherein the step of displaying includes displaying a map with a location of any participating device marked on said map.

12. The method of claim 1, further comprising printing said geographical information.

13. The method of claim 12, further comprising adding printing additional details about the participating devices.

14. The method of claim 13, wherein said devices are arranged to print said geographical information on a form containing details of a business transaction between conversation participants.

15. A device for providing information about a device participating in a telephone, or other data communication conversation, comprising:
a microprocessor for acquiring an identifier of said device;
a database for acquiring geographical information related to said identifier; and
means in said microprocessor for providing said geographical information to at least one participating device.

16. The device of claim 15, further comprising a display coupled to said at least one participating device for displaying said geographical information.

17. The device of claim 15, further comprising a memory device for storing said geographical information for a later use.

18. The device according to claim 15, wherein said geographic information is an address.

19. The device according to claim 15, wherein said geographical information is a map.

20. The device according to claim 19, wherein at least one participant location is depicted on said map.

21. The device according to claim 15, wherein said database is a built-in geographical database.

22. The device according to claim 21, wherein said database is stored on a permanent memory device.

23. The device according to claim 21, wherein said database is stored on a detachable memory device.

24. The device according to claim 15, the device being selected from the following group:
cellular phone, portable computer, desktop computer, palm computer, and computerized device which has or can be connected to communication device.

25. The device according to claim 15, further comprising a digital signal processing micro chip for decoding a transmission including geographical information.

26. The device according to claim 25, including software and a central processor unit (CPU) for decoding a transmission including geographical information.

27. A communication system comprising:
at least a first and a second device arranged to participate in a communication;
an identifier associated with each of said devices;
geographical information associated with each identifier; and
a microprocessor coupled to at least said first device and arranged to determine the identifier associated with the second device and to locate the geographical information associated with that identifier.

28. The communication system according to claim 27, wherein said identifier includes a telephone number of said second device.

29. The communication system according to claim 27, wherein said geographical information includes geographical coordinates of said second device.

30. The communication system according to claim 27, further comprising a geographical database including said identifiers and said associated geographical information.

31. The communication system according to claim 27, further comprising a printer associated with said first device for printing said geographical information.

32. The communication system according to claim 31, wherein said printer prints said geographical information on a form with additional information.

33. The communication system according to claim 32, wherein said additional information includes a map containing an address associated with said second device.

34. The communication system according to claim 32, wherein said additional information includes items to be delivered or service to be provided.

35. The communication system according to claim 33, wherein said additional information includes a preferred route between said first device and said second device.
